(19) United States
(12) Patent Application Publication
(10) Pub. No.: US 2004/0122814 A1
(43) Pub. Date: Jun. 24, 2004

(54) Matching groupings, re-aggregation avoidance and comprehensive aggregate function derivation rules in query rewrites using materialized views

(75) Inventors: Guogen Zhang, San Jose, CA (US); Ruiping Li, San Jose, CA (US); Lee-Chin Hsu Liu, San Jose, CA (US); Yun Wang, Saratoga, CA (US)

Correspondence Address: GATES & COOPER LLP, HOWARD HUGHES CENTER, 6701 CENTER DRIVE WEST, SUITE 1050, LOS ANGELES, CA, 90045, US

(73) Assignee: International Business Machines Corporation

(21) Appl. No.: 10/322,977

(22) Filed: Dec. 18, 2002

(51) Int. Cl. G06F 17/30; G06F 7/00

(52) U.S. Cl. 707/4

(57) ABSTRACT

A method, apparatus, and article of manufacture for optimizing a query in a computer system, wherein the query is performed by the computer system to retrieve data from a database stored on the computer system. The optimization includes: identifying a materialized view candidate in the computer system, matching a grouping of the materialized view with a grouping of the query using column equivalence and functional dependency, in order to determine whether re-aggregation is necessary, deriving one or more aggregate functions requested by the query from the materialized view and any remaining tables in the query based on the matched groupings, and rewriting the query based on the matched groupings.

### BACKGROUND OF THE INVENTION

1. Field of the Invention

This invention relates in general to database management systems performed by computers, and in particular, to the optimization of queries by matching groupings, re-aggregation avoidance and comprehensive aggregate function derivation rules in query rewrites using materialized views.

2. Description of Related Art

Computer systems incorporating Relational DataBase Management System (RDBMS) software using Structured Query Language (SQL) interface are well known in the art. The SQL interface has evolved into a standard language for RDBMS software and has been adopted as such by both the American Nationals Standard Institute (ANSI) and the International Standards Organization (ISO).

For most RDBMS software, combinations of tables and views are used to access data stored in tables in the database. A view definition includes a query that, if processed, provides a temporary result table based on the results of the query at that point in time. Using an INSERT statement and an appropriately defined table in the database, the temporary results table can be stored in the database. To refresh this table, the user would need to perform a DELETE from the table and then perform the INSERT again.

Users can directly query against the created table, provided that the users are aware how the results were derived. Generally, the RDBMS software is not aware that such a table is any different from any other table in the database. Moreover, this table cannot be used by an optimizer within the RDBMS software to improve performance, even though the table may contain data that would drastically improve the performance of other queries.

This leads to the notion of materialized views (MVs) or automatic summary tables (ASTs). These tables are similar to the created table described above, except that the definition of the table is based on a “full select” (much like a view) that is materialized in the table. The columns of the table are based on the elements of the select list of the full select.

Many materialized views contain summary data and are used to improve query performance through automatic query rewrite in a data warehouse environment. Summary data are obtained by using aggregate queries that group data on certain grouping columns. Matching grouping columns between a materialized view and a query is an important step in query rewrite using materialized views.

Summary data are typically organized in hierarchies. The criterion for a query to be able to use a materialized view is that the materialized view provides summary data at a level no higher than the level requested by the query. If the summary data of a materialized view is lower than the level requested by the query, re-aggregation is required to rollup the data to the desired level.

Consider the following example. If a materialized view M has the following view definition V:

SELECT T1.C1, T1.C2, SUM(T1.C3) as S

FROM T1

WHERE T1.C4>10

GROUP BY T1.C1, T1.C2;

and a query Q is:

SELECT T1.C1, SUM(T1.C3)

FROM T1

WHERE T1.C4>10

GROUP BY T1.C1;

Then, after query rewrite, query Q becomes:

SELECT M.C1, SUM(M.S)

FROM M

GROUP BY M.C1;

In many cases, the materialized view provides the summary data at the level requested by the query. In these cases, re-aggregation can be avoided. For example, if T1.C1 is the primary key of T1 in the above example, then there is no need to perform re-aggregation. After rewrite, the query Q becomes:

SELECT M.C1, M.S

FROM M;

In addition, there are many complex cases that will involve more tables in queries (what are called residual tables).

Consequently, there is a need in the art for techniques that match the grouping of a materialized view with the grouping of a query, in order to determine whether re-aggregation (also known as re-grouping) is necessary. Specifically, there is a need in the art for techniques that avoid unnecessary re-aggregation. Further, there is a need in the art for comprehensive aggregate function derivation rules in query rewrite using materialized views. The present invention satisfies these needs.

### SUMMARY OF THE INVENTION

To overcome the limitations in the prior art described above, and to overcome other limitations that will become apparent upon reading and understanding the present specification, the present invention discloses a method, apparatus, and article of manufacture for optimizing a query in a computer system, wherein the query is performed by the computer system to retrieve data from a database stored on the computer system. The optimization includes: generating a materialized view in the computer system, matching the grouping of the materialized view with the grouping of the query using column equivalence and functional dependency, in order to determine whether re-aggregation is necessary, deriving one or more aggregate functions requested by the query from the materialized view and any remaining tables in the query based on the matched groupings, and rewriting the query based on the matched groupings.

### BRIEF DESCRIPTION OF THE DRAWINGS

Referring now to the drawings in which like reference numbers represent corresponding parts throughout:

FIG. 1 illustrates an exemplary computer hardware and software environment that could be used with an embodiment of the present invention;

FIG. 2 is a flowchart illustrating the steps necessary for the interpretation and execution of SQL statements in an interactive environment according to an embodiment of the present invention;

FIG. 3 is a flowchart illustrating the steps necessary for the interpretation and execution of SQL statements embedded in source code according to an embodiment of the present invention; and

FIG. 4 is a flowchart illustrating a method of optimizing a query in a computer system, the query being performed by the computer system to retrieve data from a database stored on the computer system, according to the preferred embodiment of the present invention.

### DETAILED DESCRIPTION OF THE PREFERRED EMBODIMENT

In the following description of the preferred embodiment, reference is made to the accompanying drawings, which form a part hereof, and in which is shown by way of illustration a specific embodiment in which the invention may be practiced. It is to be understood that other embodiments may be utilized and structural and functional changes may be made without departing from the scope of the present invention.

### Hardware and Software Environment

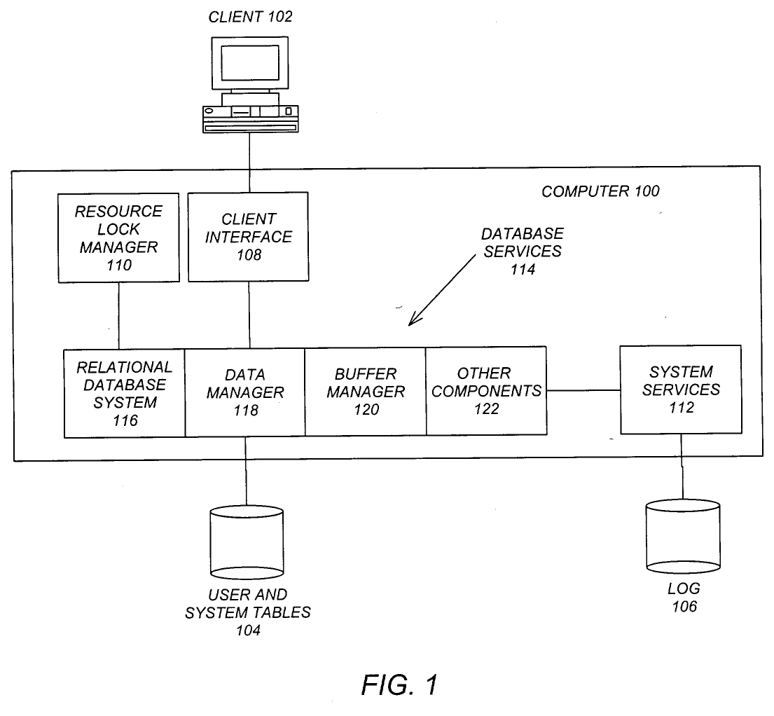

FIG. 1 illustrates an exemplary computer hardware and software environment that could be used with the present invention. In the exemplary environment, a server system 100 is connected to one or more client systems 102, in order to manage one or more databases 104 and 106 shared among the client systems 102.

Operators of the client systems 102 use a standard operator interface 108, such as IMS/DB/DC, CICS, TSO, OS/2 or other similar interface, to transmit electrical signals to and from the server system 100 that represent commands for performing various search and retrieval functions, termed queries, against the databases. In the present invention, these queries conform to the Structured Query Language (SQL) standard, and invoke functions performed by Relational DataBase Management System (RDBMS) software. In the preferred embodiment of the present invention, the RDBMS software comprises the DB2 product offered by IBM for the MVS, UNIX, WINDOWS or OS/2 operating systems. Those skilled in the art will recognize, however, that the present invention has application to any RDBMS software.

As illustrated in FIG. 1, the RDBMS includes three major components: the Resource Lock Manager (RLM) 110, the Systems Services module 112, and the Database Services module 114. The RLM 110 handles locking services, because RDBMS treats data as a shared resource, thereby allowing any number of users to access the same data simultaneously, and thus concurrency control is required to isolate users and to maintain data integrity. The Systems Services module 112 controls the overall RDBMS execution environment, including managing log data sets 106, gathering statistics, handling startup and shutdown, and providing management support.

At the heart of the RDBMS architecture is the Database Services module 114. The Database Services module 114 contains several submodules, including the Relational Database System (RDS) 116, the Data Manager 118, and the Buffer Manager 120, as well as other components 122 such as an SQL compiler/interpreter. These submodules support the functions of the SQL language, i.e., definition, access control, retrieval, and update of user and system data.

Generally, each of the components, modules, and submodules of the RDBMS comprise instructions and/or data, and are embodied in or retrievable from a computer-readable device, medium, or carrier, e.g., a memory, a data storage device, a remote device coupled to the server computer 100 by a data communications device, etc. Moreover, these instructions and/or data, when read, executed, and/or interpreted by the server computer 100, cause the server computer 100 to perform the steps necessary to implement and/or use the present invention.

Thus, the present invention may be implemented as a method, apparatus, or article of manufacture using standard programming and/or engineering techniques to produce software, firmware, hardware, or any combination thereof. The term “article of manufacture”, or alternatively, “computer program carrier”, as used herein is intended to encompass a computer program accessible from any computer-readable device, carrier, or media.

Of course, those skilled in the art will recognize many modifications may be made to this configuration without departing from the scope of the present invention. Specifically, those skilled in the art will recognize that any combination of the above components, or any number of different components, including computer programs, peripherals, and other devices, may be used to implement the present invention, so long as similar functions are performed thereby.

### Interactive SQL Execution

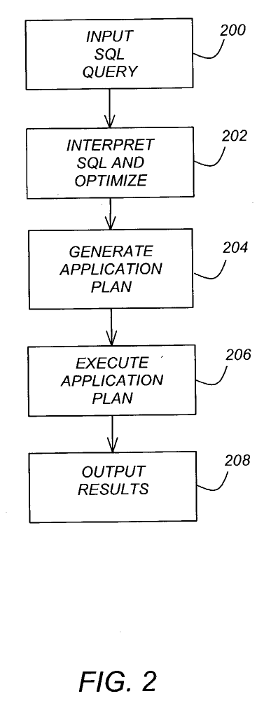

FIG. 2 is a flowchart illustrating the steps necessary for the interpretation and execution of SQL statements in an interactive environment according to the present invention. Block 200 represents the input of SQL statements into the server system 100. Block 202 represents the step of compiling or interpreting the SQL statements. An optimization function within block 202 may transform or optimize the SQL query in a manner described in more detail later in this specification. Generally, the SQL statements received as input specify only the desired data, but not how to retrieve the data. This step considers both the available access paths (indexes, sequential reads, etc.) and system held statistics on the data to be accessed (the size of the table, the number of distinct values in a particular column, etc.), to choose what it considers to be the most efficient access path for the query. Block 204 represents the step of generating a compiled set of runtime structures called an application plan from the compiled SQL statements. Block 206 represents the execution of the application plan and Block 208 represents the output of the results.

### Embedded/Batch SQL Execution

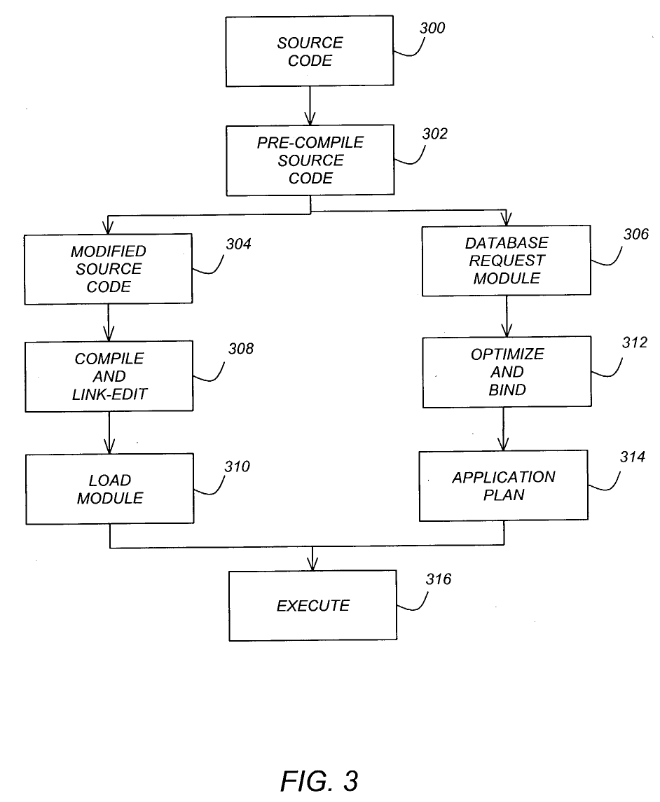

FIG. 3 is a flowchart illustrating the steps necessary for the interpretation and execution of SQL statements embedded in source code according to the present invention. Block 300 represents program source code containing a host language (such as COBOL or C) and embedded SQL statements. The program source code is then input to a pre-compile step 302. There are two outputs from the pre-compile step 302: a modified source module 304 and a Database Request Module (DBRM) 306. The modified source module 304 contains host language calls to the RDBMS, which the pre-compile step 302 inserts in place of SQL statements. The DBRM 306 is comprised of the SQL statements from the program source code 300. A compile and link-edit step 308 uses the modified source module 304 to produce a load module 310, while an optimize and bind step 312 uses the DBRM 306 to produce a compiled set of runtime structures for the application plan 314. As indicated above in conjunction with FIG. 2, the SQL statements from the program source code 300 specify only the desired data, but not how to retrieve the data. The optimize and bind step 312 may optimize the SQL query in a manner described in more detail later in this specification. Thereafter, the optimize and bind step 312 considers both the available access paths (indexes, sequential reads, etc.) and system held statistics on the data to be accessed (the size of the table, the number of distinct values in a particular column, etc.), to choose what it considers to be the most efficient access path for the query. The load module 310 and application plan 314 are then executed together at step 316.

### Description of the Optimization Technique

The present invention discloses an improved optimization technique that is typically performed at step 202 of FIG. 2 or step 312 of FIG. 3. Specifically, the present invention discloses an improved method for optimizing queries using grouping matching, re-aggregation avoidance and comprehensive aggregate function derivation rules in query rewrites using materialized views.

Specifically, the present invention provides logic for matching the grouping of a materialized view with the grouping of a query and then determining whether re-aggregation (also known as re-grouping) is necessary using column equivalence and functional dependency. These steps provide the best strategy for avoiding unnecessary re-aggregation.

Without this logic for matching groupings, there are two possible consequences: (1) a materialized view candidate is rejected due to unrecognized equivalent columns or functional dependencies, or (2) re-aggregation is performed when there is actually no need to perform re-grouping due to the same reasons, leading to extra cost and lower performance.

After matching groupings between a materialized view and a query, aggregate functions requested by the query need to be derived from the materialized view and any remaining tables in the query. The derivation depends on the matching groupings decision, i.e., whether the RDBMS needs to perform re-aggregation or not.

It also depends on the argument of the aggregate function, e.g., whether it is from a common table or a residual table. If the summary data of a materialized view is lower than the level of what is requested by a query, then re-aggregation is required to rollup the data to the desired level.

Consider the following example. If a materialized view M has the following view definition V:

SELECT T1.C1, T1.C2, SUM(T1.C3) as S, COUNT(T1.C3) as CT

FROM T1

WHERE T1.C4>10

GROUP BY T1.C1, T1.C2;

and a query Q is:

SELECT T2.C2, AVG(T1.C3)

FROM T1, T2

WHERE T1.C1=T2.C1 AND T1.C4>10

GROUP BY T2.C2;

After query rewrite, assuming re-grouping is needed, query Q becomes:

SELECT T2.C2,

CASE SUM(M.CT)=0

THEN NULL ELSE SLM(M.S)/SUM(M.CT) END

FROM M, T2

WHERE M.C1=T2.C1

GROUP BY T2.C2;

If there is no need to perform re-aggregation, then, after query rewrite, the query Q becomes:

SELECT M.C1,

CASE M.CT=0

THEN NULL ELSE M.S/M.CT END

FROM M, T2

WHERE M.C1=T2.C1;

In addition, the present invention provides a set of comprehensive aggregate function derivation rules that are the most complete when combined with commonly known derivation rules. With this set of rules, coupled with the most complete logic for matching groupings and re-grouping avoidance, the present invention can achieve the best solution for aggregate query rewrite using materialized views. Using this invention, more queries can benefit from materialized views and achieve performance advantages.

A. Concepts and Notations

Before detailed logic of the invention is presented, some concepts and notations are introduced below.

In the logic for matching groupings of query Q and view definition V for materialized view M, there is a need to map the tables involved in Q and V. The following terminology is used to refer to the tables involved:

Common tables: tables appear in the FROM clause of both Q and V. Usually common tables in Q are replaced by materialized view M after query rewrite.

Residual tables: tables appear in the FROM clause of Q only. After query rewrite, these tables remain in the query.

Rejoin tables: common tables that remain in the query after query rewrite to derive non-key columns through joins using primary keys.

Extra tables: tables appear in the FROM clause of V only. These tables are not used for the query.

Without loss of generality, assume that both query Q and view definition V of materialized view M contain a single query block and grouping columns. Then, the following are defined:

(Cc1, Cc2, . . . ) are grouping columns appearing in the grouping lists of both the query Q and V;

(Cq1, Cq2, . . . ) are grouping columns (from common tables) appearing only in the grouping list of query Q (extra columns in Q);

(Cv1, Cv2, . . . ) are grouping columns appearing only in the grouping list of the view definition V of materialized view M (extra columns in V); and

(Cr1, Cr2, . . . ) are grouping columns from residual tables appearing in the grouping list of query Q.

Finally, an arrow (→) has two meanings depending on the context. An arrow (→) notation between columns (e.g., A→B) indicates that the columns on the left hand functionally determine the columns on the right hand side (i.e., A functionally determines B, or A contains B). The other use of an arrow in the derivation rules indicates a column name is specified for an expression on the left hand in the result table.

B. Matching Groupings and Re-aggregation Avoidance for Query Rewrite Using Materialized Views

The present invention provides logic for matching the grouping of a materialized view with the grouping of a query and then determines whether re-aggregation (also known as re-grouping) is necessary using column equivalence and functional dependency. These steps provide the best strategy for avoiding unnecessary re-aggregation.

Without this logic for matching groupings, there are two possible consequences: (1) a materialized view candidate is rejected due to unrecognized equivalent columns or functional dependencies, or (2) re-aggregation is performed when there is actually no need to perform re-grouping due to the same reasons, leading to extra cost and lower performance.

### 1. Matching Groupings Logic

The logic for matching groupings distinguishes between cases without residual table columns and cases with residual table columns involved in the grouping list of the query.

1.1 Matching Groupings Logic When there are no Grouping Columns from Residual Tables

The following table summarizes the matching groupings logic for the grouping columns when there are no residual tables involved (although rejoin tables may be involved):

TABLE 1
Matching groupings logic when there are no grouping columns from residual tables

| Grouping column | | | |
|---|---|---|---|
| relationship | Matching Requirement | Re-grouping check A | Rejoin |
| 1. Exact match | No more | No | No |
| 2. Extra columns in V | None | If (Cc1, Cc2, . . . ) -> | No |
| only | | (Cv1, Cv2, . . . ) then No | |
| | | else Yes | |
| 3. Extra columns in Q | (Cc1, Cc2, . . . ) -> (Cq1, | No | If any of Cq1, Cq2, . . . |
| only | Cq2, . . . ) | | are columns of |
| | | | common tables, and |
| | | | any of them and their |
| | | | equivalent columns are |
| | | | not in the SELECT list |
| | | | of V, then Yes, else No |
| 4. Extra columns in | (Cc1, Cc2, . . . , Cv1, Cv2, | If (Cc1, Cc2, . . . , Cq1, | Same as above |
| both Q and V | . . . ) -> (Cq1, Cq2, . . . ) | Cq2, . . . ) -> (Cv1, Cv2, | |
| | | . . . ) then No else Yes | |

For the example given in the first section, there are no residual tables, and there is an extra grouping column T1.C2 in V only (Cv in case 2 of Table 1). If T1.C1 is the primary key of T1, then T1.C1→T1.C2 (i.e., Cc's→Cv's), and therefore, there is no need to re-group.

If the above table indicates that no re-grouping is required after re-grouping check A, the RDBMS needs to conduct a re-grouping check B: if a residual table exists in the FROM list of Q, then the RDBMS needs to determine whether the residual table join columns to M are all the columns of a primary key or unique index key. If not, re-grouping is still required. If more than one residual table is involved, a similar condition applies to the rest of residual tables, transitively. In this logic, the RDBMS does not care about local predicates and NOT NULL property.

For example, assume a materialized view Ml with the following view definition V1:

SELECT T1.C1, T1.C2, SUM(T1.C3) as S

FROM T1

WHERE T1.C4>10

GROUP BY T1.C1, T1.C2

and a query Q1:

SELECT T1.C1, T2.C2, SUM(T1.C3)

FROM T1, T2

WHERE T1.C2=T2.C2 AND T1.C4>10

GROUP BY T1.C1, T2.C2;

Because of the column equivalence T1.C2=T2.C2, the grouping columns T1.C2 and T2.C2 match each other. Therefore, this is a case of exact match with a residual table T2. Without any other assumptions, after query rewrite, query Q1 becomes:

SELECT M1.C1, T2.C2, SUM(M1.S)

FROM M1, T2

WHERE M1.C2=T2.C2

GROUP BY M1.C1, T2.C2;

Now, if it is assumed that T2.C2 is the primary key of T2, then according to re-grouping check B, no re-grouping is necessary. Therefore, after query rewrite, Q1 becomes:

SELECT M1.C1, T2.C2, M1.S

FROM M1, T2

WHERE M1.C2=T2.C2;

1.2 Matching Groupings Logic When there Are Grouping Columns from Residual Tables

When there are residual tables in Q and their columns appear in grouping columns, the RDBMS further separates grouping columns in query Q into those belonging to common tables (using Cq1, Cq2, . . . ) and those belonging to residual tables (Cr1, Cr2, . . . ). The following table summarizes the matching groupings logic for the grouping columns when there are residual tables involved and their columns appear as the grouping columns.

TABLE 2
Matching groupings logic when there are residual table columns used as grouping columns

| Grouping column | Matching Requirement | | |
|---|---|---|---|
| relationship (except for | (In addition to: the | | |
| those from residual | residual tables can join | | |
| tables Cr1, Cr2, . . . ) | with M) | Re-grouping check C | Rejoin |
| 5. Exact match | No more | If (Cc1, Cc2, . . . ) -> | No |
| | | (Cr1, Cr2, then No | |
| | | else Yes | |
| 6. Extra columns in V | None | If (Cc1, Cc2, . . . Cr1, | No |
| only | | Cr2, . . . ) -> (Cv1, Cv2, | |
| | | . . . ) and (Cc1, Cc2, . . . , | |
| | | Cv1, Cv2, . . . ) -> (Cr1, | |
| | | Cr2, . . . ) then No else | |
| | | Yes | |
| 7. Extra Columns in Q | (Cc1, C2, . . . ) -> (Cq1, | If (Cc1, Cc2, . . . ) -> | If any of Cq1, Cq2, . . . |
| only | Cq2, . . . ) | (Cr1, Cr2, . . . ) then No | are columns of |
| | | else Yes | common tables, and |
| | | | any of them and their |
| | | | equivalent columns are |
| | | | not in the SELECT list |
| | | | of V, then Yes, else No |
| 8. Extra Columns in | (Cc1, Cc2, . . . , Cv1, Cv2, | If (Cc1, Cc2, . . . , Cq1, | Same as above |
| both Q and V | . . . ) -> (Cq1, Cq2, . . . ) | Cq2, . . . , Cr1, Cr2, . . . ) -> | |
| | | (Cv1, Cv2, . . . ) and (Cc1, | |
| | | Cc2, . . . , Cv1, Cv2, . . . ) -> | |
| | | (Cr1, Cr2, . . . ) then | |
| | | No else Yes | |

After the re-grouping check C in Table 2 indicates that no re-grouping is required, the RDBMS needs to perform the re-grouping check B defined earlier following Table 1.

The following is an example with a residual table column as a grouping column. Assuming materialized view M2 has the view definition V2 as follows (same as M1):

SELECT T1.C1, T1.C2, SLM(T1.C3) as S

FROM T1

WHERE T1.C4>10

GROUP BY T1.C1, T1.C2;

and a query Q2:

SELECT T1.C1, T2.C3, SUM(T1.C3)

FROM T1, T2

WHERE T1.C2=T2.C2 AND T1.C4>10

GROUP BY T1.C1, T2.C3;

There is a residual table T2 in Q2, and a common grouping column (Cc's): T1.C1, an extra grouping column in V2 (Cv's): T1.C2, and an extra grouping column in Q2 from a residual table (Cr's): T2.C3. According to case 6 of Table 2 (Cr's are ignored for the first column in the table), M2 and Q2 match. Without any other assumption, re-grouping is required. After query rewrite, query Q2 becomes:

SELECT M2.C1, T2.C3, SUM(M2.S)

FROM M2, T2

WHERE M2.C2=T2.C2

GROUP BY M2.C1, T2.C3;

If it is assumed that both T1.C1 and T2.C2 are the primary key of T1 and T2, respectively, then T1.C1→T1.C2 (i.e. Cc's→Cv's), and T1.C1→T1.C2=T2.C2→T2.C3 (i.e. Cc's→Cr's). Therefore, according to Table 2 case 6 and the fact that there are no other residual tables, no re-grouping is necessary. Therefore, after query rewrite, Q2 becomes:

SELECT M1.C1, T2.C3, M.S

FROM M1, T2

WHERE M1.C2=T2.C3;

Notice that, even if Q and V does not have any grouping columns in common, they can still match. To illustrate this, consider a modified version of the previous example involving a residual table in the following materialized view M3 with view definition V3:

SELECT T1.C1, SUM(T1.C3) as S

FROM T1

WHERE T1.C4>10

GROUP BY T1.C1;

and a query Q3:

SELECT T2.C2, SUM(T1.C3)

WHERE T1.C1=T2.C AND T1.C4>10

GROUP BY T2.C2;

There are empty Cc's, an extra grouping column in V3 (Cv's): T1.C1, and an extra grouping column from a residual table in Q3 (Cr's): T2.C2. According to case 6 in Table 2, the grouping matches, but re-grouping is needed. After query rewrite, query Q3 becomes:

SELECT T2.C2, SUM(M3.S)

FROM M, T2

WHERE M3.C1=T2.C1

GROUP BY T2.C2

However, if T2.C1 is the primary key of T2, and T2.C2 is a NOT NULL unique index column for T2, then T1.C1=T2.C1→T2.C2 (i.e. Cv's→Cr's) and T2.C2→T2.C1=T1.C1 (i.e. Cr's→Cv's). Therefore, no re-grouping is necessary. After query rewrite, query Q3 becomes:

SELECT T2.C2, M3.S

FROM M3, T2

WHERE M3.C1=T2.C1;

### 2. Functional Dependencies

In the previous matching groupings logic, functional dependency relationships are a key element in determining whether groupings match and whether re-grouping is necessary.

Assume that K is a set of columns, the functional dependency takes one of the following forms:

1) If K contains a primary key of table T, then K functionally determines all the rest of the columns of T.

2) If K contains index key columns of a NOT NULL unique index of table T, then K functionally determines all the rest of the columns of T.

3) After replacement of columns with their equivalent columns, K satisfies one of the above conditions.

Following is an algorithm that is used to check functional dependencies. In general, (Ca1, Ca2, . . . )→(Cb1, Cb2 . . . ) if and only if (Ca1, Ca2, . . . )→Cb1, (Ca1, Ca2, . . . )→Cb2, etc. and if (Ca1, Ca2)→Cb1, then (Ca1, Ca2, Cx)→Cb1.

To check for a functional dependency in (Ca1, Ca2, . . . )→Cb1, the RDBMS determines whether any of the determinants of Cb1 is in (Ca1, Ca2, . . . ). If so, then (Ca1, Ca2, . . . )→Cb1.

The following recursive algorithm can be used to check whether or not the functional dependency holds.

Denote set (Ca1, Ca2, . . . ) as L.

FDChecking(L, Cb1)
1) Determine whether column Cb1 or any of its
equivalent columns is already examined.
If yes, return the remembered result. (This
will avoid possibility of an infinite loop.)
Otherwise, determine whether column Cb1 or
any of its equivalent columns is in L.
If yes, return true.
Otherwise, continue.
2) Loop through Cb1 and all of its equivalent
columns until return = “true”
For each column, Ci, find the primary key or
NOT NULL unique index of the table to which
Ci belongs.
For columns of each key, ki, i = 1, . . . ,
n, return = FDChecking(L, ki) AND . . . AND
FDChecking(L, kn).
Also, remember the result for each column for
use in avoiding infinite loop.

For example, to prove (C1, C2, C3)→C4 given the following assumptions:

1. Equivalent column of C4:C5;

2. Primary key for the table of C4:C6 and C7, unique index column:C8;

3. Primary key for the table of C5:C9;

If the RDBMS can prove that the set of C1, C2, and C3 contains either C4 or C5, or otherwise, either C6 and C7, or C8, or C9, then it achieves the goal.

C. Comprehensive Aggregate Function Derivation Rules in Query Rewrite Using Materialized Views

As noted above, after matching groupings between a query and a materialized view, aggregate functions requested by the query need to be derived from the materialized view and any remaining tables in the query. The derivation depends on the results from the matching groupings logic, i.e., whether re-aggregation needs to be performed. It also depends on the argument of the aggregate function, e.g., whether it is from a common table or a residual table. If the summary data of a materialized view is lower than the level of what is requested by the query, re-aggregation is required to rollup the data to the desired level.

### 1. Basic Concepts

Re-aggregation or re-grouping aggregates the aggregated data from the materialized views to obtain the summary data requested by the query.

Consider the following example:

M:

SELECT T1.C1, T1.C2, SUM(T1.C3) as S

FROM T1

WHERE T1.C4>10

GROUP BY T1.C1, T1.C2;

Q:

SELECT T1.C1, SUM(T1.C3)

FROM T1

WERE T1.C4>10

GROUP BY T1.C1;

After query rewrite using M, re-aggregation is needed for Q:

SELECT M.C1, SUM(M.S)

FROM M

GROUP BY M.C1;

This application uses some notations to represent the query rewrite rule on which the previous query rewrite is based, by ignoring the predicate part:

Gamma (

GROUPING COLUMNS,
AGGREGATE FUNCTION -> COLUMN, . . . ,
TABLE)

In the above, Gamma( ) is an aggregation operator that applies to the last argument, i.e., a table. An arrow (→) following the aggregate function is to specify a name for the column corresponding to the aggregate function for the result table of Gamma( ).

Consider the following example:

Gamma(T1.C, SUM(T1.C3), T1)=Gamma(T1.C1, SUM(S), Gamma(T1.C1, T1.C2, SUM(T1.C3)→S, T1))

The inner Gamma( ) in the above rule matches the definition of M (except for the implicit predicate). Therefore, the following can be derived:

Gamma(T1.C1, SUM(S), Gamma(T1.C1, T1.C2, SUM(T1.C3)→S, T1))=Gamma(T1.C1, SUM(S), M)

The right hand side of the above is translated into the rewritten query shown above.

Select (T1.C1, . . . , T1) is projection from the last argument, that is, to get all the columns and expressions from the last argument, which is a table.

The aggregate functions include: COUNT, SUM, MAX, MIN, AVG, VAR, STDDEV, VAR_SAMP, and STDDEV_SAMP, and their arguments can have an optional DISTINCT modifier.

1) COUNT: either COUNT is in M or the argument (if not *) can derived from M;

2) SUM: either SUM is in M or its argument can be derived from M

3) MAX: either MAX is in M or its argument can be derived from M

4) MIN: either MIN is in M or its argument can be derived from M

5) AVG: either AVG, or both SUM and COUNT with the same argument are in M, or its argument can be derived from M.

6) VAR: either VAR, or all of SUM, COUNT, and SUM of its argument squared are in M, or its argument can be derived from M.

7) STDDEV: either VAR, STDDEV, or all of SUM, COUNT, and SUM of its argument squared are in M, or its argument can be derived from M.

8) VAR_SAMP and STDDEV_SAW are similar to VAR and STDDEV.

The derivation of MAX and MIN is straightforward, and AVG, VAR, STDDEV, VAR_SAW, and STDDEV_SAMP can be converted into an expression of SUM and COUNT:

AVG(X)=SUM(X)/COUNT(X)

VAR(X)=SUM(X*X)/COUNT(X)−(SUM(X)/COUNT(X))*

(SUM(X)/COUNT(X))

STDDEV(X)=SQRT(VAR(X))

VAR_SAMP(X)=SUM(X*X)/COUNT(X)−

SUM(X)*SUM(X)/(COUNT(X)*(COUNT(X)−1))

STDDEV_SAMP(X)=SQRT(AR_SAMP(X)

Consequently, this application will only present rules for SUM and COUNT in the following description, and the other functions can be derived therefrom Note that if a column C is not null, COUNT(C)=COUNT(*).

### 2. Derivation Rules

Two tables T1 and T2 are used to represent common tables and residual tables. They can be result of some joins of tables with local predicates. The rules are divided for cases requiring re-grouping and no re-grouping.

2.1 With Re-grouping

When the grouping matching logic determines that re-grouping is necessary, the following rules apply.

2.1.1 Only Columns of Common Tables are Involved

Rule 1.

Gamma(T1.A, SUM(T1.D)→S, COUNT(T1.D)→C, T1)=Gamma(T1.A, SUM(S1)→S, SUM(C1)→C, Gamma(T1.A, T1.B, SUM(T1.D)→S1, COUNT(T1.D)→C1, T1))

That is, if S1=SUM(T1.D), and C1=COUNT(T1.D), with re-grouping, then SUM(S1)=>SUM(T1.D) and SUM(C1)=>COUNT(T1.D), where “=>” means “leads to”.

Rule 2.

Gamma(T1.A, SUM(T1.D)→S, COUNT(T1.D)→C, T1)=Gamma(T1.A, SUM(T1.D)→S, COUNT(T1.D)→C, Select(T1.A, T1.B, T1.D, T1))

This rule applies to the case that a materialized view does not have a group-by.

Rule 3.

Gamma(T1.A, SUM(T1.D)→S, COUNT(T1.D)→C, T1 JOIN T2)=Gamma(T1.A, SUM(S1)→S, SUM(C1)→C, Gamma(T1.A, T1.B, SUM(T1.D)→S1, COUNT(T1.D)→C1, T1) JOIN T2)

This rule applies to the case that a query contains a residual table, but columns of the residual table do not appear in the group-by or in set functions.

Rule 4.

Gamma(T1.A, SUM(Distinct T1.D)→S, COUNT(Distinct T1.D)→C, Ti)=Gamma(T1.A, SUM(Distinct T1.D)→S, COUNT(Distinct T1.D)→C Gamma(T1.A, T1.B, T1.D, SUM(T1.E)→Se, T1))

This rule is to derive set functions with DISTINCT from grouping columns of a materialized view.

2.1.2 Columns of Residual Tables are Involved

Rule 5.

Gamma(T1.A, T2.B, SUM(T1.D)→Sd, COUNT(T1.D)→Cd, SUM(T2.E)→Se, COUNT(T2.E)→Ce, T1 JOIN T2)=Gamma(T1.A, T2.B, SUM(Sd1)→Sd, SUM(Cd1)→Cd, SUM(T2.E)*Ct→Se, COUNT(T2.E)*Ct→Ce, Gamma(T1.A, T1.J, SUM(T1.D)→Sd1, COUNT(T1.D)→Cd1, COUNT(*)→Ct, T1) JOIN T2)

In the above rule, T1 JOIN T2 is some join condition between T1 and T2 involving column T1.J. If this column is T1.A, then this T1.J is not needed on the right hand side. T1.A and T2.B are just representative of the columns from T1 and T2. The number of columns is not limited. This rule applies to the case that a query contains a residual table and its columns appear in group-by and set functions.

Special cases can be derived from this rule for general cases. When the materialized view does not have a group-by, the following rule applies.

Rule 6.

Gamma(T1.A, T2.B, SUM(T1.D)→Sd, COUNT(T1.D)→Cd, SUM(T2.E)→Se, COUNT(T2.E)→Ce, T1 JOIN T2)=Gamma(T1.A, T2.B, SUM(T1.D)→Sd, COUNT(T1.D)→Cd, SUM(T2.E)→Se, COUNT(T2.E)→Ce, Select(T1.A, T1.J, T1.D, T1) JOIN T2)

2.2 No Re-grouping

When the grouping matching logic determines that no re-grouping is necessary, the following rules apply.

2.2.1 Only Columns of Common Tables are Involved

Rule 7.

Gamma(T1.A, SUM(T1.D)→S, COUNT(T1.D)→C, T1)=Select(T1.A, S1→S, C1→C, Gamma(T1.A, T1.B, SUM(T1.D)→S1, COUNT(T1.D)→C1, T1))

In the above rule, Select( ) is the projection from the last argument, which is a table, and S1→S is to rename S1 as S.

Rule 8.

Gamma(T1.A, SUM(Distinct T1.D)→S, COUNT(Distinct T1.D)→C, T1)=Select(T1.A, S1→S, C1→C, Gamma(T1.A, T1.B, SUM(Distinct T1.D)→S1, COUNT(Distinct T1.D)→C1, T1))

2.2.2 Columns of Residual Tables are Involved

Rule 9.

Gamma(T1.A, T2.B, SUM(T1.D)→Sd, COUNT(T1.D)→Cd, SUM(T2.E)→Se, COUNT(T2.E)→Ce, T1 JOIN T2)=Select(T1.A, T2.B, Sd1→Sd, Cd1→Cd, T2.E*Ct→Se, Cd1→Ce, Gamma(T1.A, T1.J, SUM(T1.D)→Sd1, COUNT(T1.D)→Cd1, COUNT(*)→Ct, T1) JOIN T2)

Rule 10.

Gamma(T1.A, T2.B, SUM(Distinct T1.D)→Sd, COUNT(Distinct T1.D)→Cd, SUM(T2.E)→Se, COUNT(T2.E)→Ce, T1 JOIN T2)=Select(T1.A, T2.B, Sd1→Sd, Cd1→Cd, T2.E*Ct→Se, Cd1→Ce, Gamma(T1.A, T1.J, SUM(Distinct T1.D)→Sd1, COUNT(Distinct T1.D)→Cd1, COUNT(*)→Ct, T1) JOIN T2)

### 3. Examples

This section presents some examples corresponding to the derivation rules in Section 2.

### Example for Rule 3

Consider a materialized view M1 with the following view definition V1:

SELECT T1.A, T1.B, SUM(T1.D) as S1, COUNT(T1.D) as C1

FROM T1

GROUP BY T1.A, T1.B;

and a query example Q1:

SELECT T1.A, SUM(T1.D), COUNT(T1.D)

FROM T1, T2, T3

WHERE T1.B=T2.B AND T2.C=T3.C

GROUP BY T1.A;

Applying the rule, Q1 can be rewritten to the following:

SELECT M1.A, SUM(M1.S1), SUM(M1.C1)

FROM M1, T2, T3

WHERE M1.B=T2.B AND T2.C=T3.C

GROUP BY M1.A;

### Example for Rule 5

Consider a materialized view M2 with the following view definition V2:

SELECT T1.A, T1.J, SUM(T1.D) as Sd1, COUNT(T1.D) as Cd1, COUNT(*) as Ct

FROM T1

GROUP BY T1.A, T1.J;

and a query example Q2:

SELECT T1.A, T2.B, SUM(T1.D) as Sd, COUNT(T1.D) as Cd, SUM(T2, E) as Se, COUNT(T2.E) as Ce

FROM T1, T2

WHERE T1.J=T2.J

GROUP BY T1.A, T2.B;

Applying the rule, Q2 can be rewritten to the following:

SELECT M2.A, T2.B, SUM(M2.Sd1) Sd, SUM(M2.Cd1) Cd, SUM(T2.E)*M2.Ct as Se, COUNT(T2.E)*M2.Ct as Ce

FROM M2, T2

WHERE M2.J=T2.J

GROUP BY M2.A, T2.B;

### Example for Rule 7

Consider a materialized view M3 with the following view definition V3:

SELECT T1.A, T1.B, SUM(T1.D) as S1, COUNT(T1.D) as C1

FROM T1

GROUP BY T1.A, T1.B

and a query example Q3:

SELECT T1.A, SUM(T1.D) as S, COUNT(T1.D) as C

FROM T1

GROUP BY T1.A

Applying the rule, Q3 can be rewritten to the following (assuming T1.A is the primary key of T1, so that no re-grouping is needed):

SELECT M3.A, M3.S1 as S, M3.C1 as C

FROM M3

### Example for Rule 9

Consider a materialized view M4 with the following view definition V4:

SELECT T1.A, T1.J, SUM(T1.D) as Sd1, COUNT(T1.D) as Cd1, COUNT(*) as Ct

FROM T1

GROUP BY T1.A, T1, J;

and a query example Q4:

SELECT T1.A, T2.B, SUM(T1.D) as Sd, COUNT(T1.D) as Cd, SUM(T2.E) as Se, COUNT(T2.E) as Ce

FROM T1, T2

WHERE T1.J=T2.J

GROUP BY T1.A, T2.B;

Applying the rule, Q4 can be rewritten to the following (assuming that the re-grouping rule indicates that there is no need to re-grouping, for example, T2.J is the primary key of T2 and T2 has a unique index on T2.B):

SELECT M4.A, T2.B, M4.Sd1 as Sd, M4.Cd1 as Cd, T2.E*M4.Ct as Se, M4.Cd1 as Ce FROM M4J=T2.J;

### Logic of the Preferred Embodiment

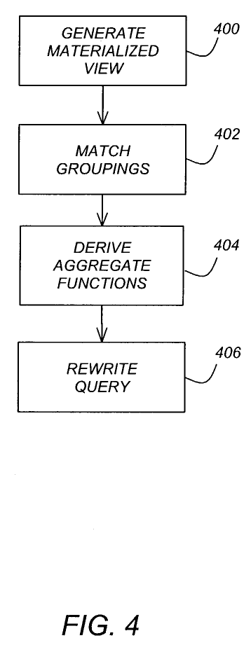

FIG. 4 is a flowchart illustrating a method of optimizing a query in a computer system, the query being performed by the computer system to retrieve data from a database stored on the computer system, according to the preferred embodiment of the present invention.

Block 400 represents the RDBMS identifying a materialized view candidate in the computer system.

Block 402 represents the RDBMS matching a grouping of the materialized view with a grouping of the query using column equivalence and functional dependency, in order to determine whether re-aggregation is necessary.

In one aspect, Block 402 represents the RDBMS performing the following logic for matching the grouping of the materialized view with the grouping of the query when there are no grouping columns from residual tables:

if there is an exact match between grouping columns, then there is no other matching requirement, no re-grouping and no rejoin;

if there are one or more extra columns in the view definition for the materialized view only, then there is no other matching requirement, re-grouping is needed (check A) if grouping columns appearing in the grouping lists of both the query and the view definition do not functionally determine the grouping columns appearing only in the grouping list for the view definition, and no rejoin is needed;

if there are one or more extra columns in the query only, then there is a matching requirement that grouping columns appearing in the grouping lists of both the query and the view definition for the materialized view functionally determine the grouping columns appearing only in the grouping list of the query, no re-grouping is needed, and a rejoin is required if the grouping columns appearing only in the grouping list for the query are columns of common tables and any of them and their equivalent columns are not in a SELECT list of the query, and

if there are one or more extra columns in both the view definition for the materialized view and the query, then there is a matching requirement that grouping columns appearing in the grouping lists of both the query and the view definition and the grouping columns appearing only in the grouping list for the view definition functionally determine the grouping columns appearing only in the grouping list for the query, re-grouping is needed (check A) if the grouping columns appearing in the grouping lists of both the query and the view definition and the grouping columns appearing only in the grouping list for the query do not functionally determine the grouping columns appearing only in the grouping list for the view definition, and a rejoin is required if the grouping columns appearing only in the grouping list for the query are columns of common tables and any of them and their equivalent columns are not in a SELECT list of the query.

When no re-grouping is required from re-grouping check A above, then a regrouping check B is performed by the RDBMS: if a residual table exists in a FROM list of the query, then determining whether the residual table's join columns to the materialized view are all columns of a unique index key, and, if not, performing a re-grouping.

In one aspect, Block 402 represents the RDBMS performing the following logic for matching the grouping of the materialized view with the grouping of the query when there are residual table columns used as grouping columns:

if there is an exact match between grouping columns (without considering columns from residual tables), then there is no other matching requirement, re-grouping is needed (check C) if the grouping columns appearing in the grouping lists of both the query and the view definition for the materialized view do not functionally determine the grouping columns from residual tables appearing in the grouping list for the query, and no rejoin is needed;

if there are one or more extra columns in the view definition for the materialized view only (without considering columns from residual tables), then there is no other matching requirement, re-grouping is needed (check C) if grouping columns appearing in the grouping lists of both the query and the view definition and the grouping columns from residual tables appearing in the grouping list for the query do not functionally determine the grouping columns appearing only in the grouping list for the view definition and the grouping columns appearing in the grouping lists of both the query and the view definition and the grouping columns appearing only in the grouping list for the view definition do not functionally determine the grouping columns from the residual tables appearing in the grouping list for the query, and no rejoin is needed;

if there are one or more extra columns in the query only (without considering columns from residual tables), then there is a matching requirement that grouping columns appearing in the grouping lists of both the query and a view definition for the materialized view functionally determine the grouping columns appearing only in the grouping list of the query re-grouping is required (check C) if the grouping columns appearing in the grouping lists of both the query and the view definition do not functionally determine the grouping columns from residual tables appearing in the grouping list of the query, and a rejoin is needed if the grouping columns appearing only in the grouping list of the query are columns of common tables and any of them and their equivalent columns are not in a SELECT list of the query, and

if there are one or more extra columns in both a view definition for the materialized view and the query (without considering columns from residual tables), then there is a matching requirement that grouping columns appearing in the grouping lists of both the query and the view definition and the grouping columns appearing only in the grouping list of the view definition functionally determine the grouping columns appearing only in the grouping list of the query, re-grouping is required (check C) if the grouping columns appearing in the grouping lists of both the query and the view definition and the grouping columns appearing only in the grouping list of the query and the grouping columns of the residual tables appearing in the grouping list of the query do not functionally determine the grouping columns appearing only in the grouping list of the view definition and the grouping columns appearing in the grouping lists of both the query and the view definition and the grouping columns appearing only in the grouping list of the view definition do not functionally determine the grouping columns of the residual tables appearing in the grouping list of the query, and a rejoin is needed if the grouping columns appearing only in the grouping list of the query are columns of common tables and any of them and their equivalent columns are not in a SELECT list of the query.

The functional dependency used by the RDBMS in Block 402 comprises the following:

if a set of columns contains a primary key of a table, then the set of columns functionally determines all remaining columns of the table;

if the set of columns contains index key columns of a NOT NULL unique index of the table, then the set of columns functionally determines all the remaining columns of the table;

after replacement of columns with their equivalent columns, the set of columns satisfies one of the above conditions; and

recursively determining whether the functional dependency holds for the columns.

Block 404 represents the RDBMS deriving one or more aggregate functions requested by the query from the materialized view and any remaining tables in the query based on the results from matching the grouping of the materialized view with the grouping of the query, i.e., when Block 402 indicates that re-aggregation needs to be performed, and/or based on an argument of the aggregate functions. The step of deriving the aggregate functions may occur: (1) with re-grouping involving columns of common tables, (2) with re-grouping involving columns of residual tables, (3) without re-grouping involving columns of common tables, or (4) without re-grouping involving columns of residual tables.

Block 406 represents the RDBMS rewriting the query based on the results from matching the grouping of the materialized view with the grouping of the query.

### Conclusion

This concludes the description of the preferred embodiment of the invention. The following describes some alternative embodiments for accomplishing the present invention. For example, any type of computer, such as a mainframe, minicomputer, or personal computer, could be used with the present invention. In addition, any software program performing database queries with grouping and/or aggregation could benefit from the present invention.

In summary, the present invention discloses a method, apparatus, and article of manufacture for optimizing a query in a computer system, wherein the query is performed by the computer system to retrieve data from a database stored on the computer system. The optimization includes: identifying a materialized view candidate in the computer system, matching the grouping of the materialized view with the grouping of the query using column equivalence and functional dependency, in order to determine whether re-aggregation is necessary, deriving one or more aggregate functions requested by the query from the materialized view and any remaining tables in the query based on the matched groupings, and rewriting the query based on the matched groupings.

The foregoing description of the preferred embodiment of the invention has been presented for the purposes of illustration and description. It is not intended to be exhaustive or to limit the invention to the precise form disclosed. Many modifications and variations are possible in light of the above teaching.

What is claimed is:

1. A method of optimizing a query in a computer system, the query being performed by the computer system to retrieve data from a database stored on the computer system, the method comprising:
(a) identifying a materialized view candidate;
(b) matching a grouping of the materialized view with a grouping of the query using column equivalence and functional dependency, in order to determine whether re-aggregation is necessary; and
(c) rewriting the query based on the matched groupings.

2. The method of claim 1, wherein the matching step further comprises:
if there is an exact match between grouping columns, then there is no further matching requirement, no re-grouping and no rejoin are necessary.

3. The method of claim 1, wherein the matching step further comprises:
if there are one or more extra columns in a view definition for the materialized view only, then there is no other matching requirement, re-grouping is required if grouping columns appearing in grouping lists of both the query and the view definition do not functionally determine the grouping columns appearing only in the grouping list of the view definition, and no rejoin is needed.

4. The method of claim 1, wherein the matching step further comprises:
if there are one or more extra columns in the query only, then there is a matching requirement that grouping columns appearing in grouping lists of both the query and a view definition for the materialized view functionally determine the grouping columns appearing only in the grouping list of the query, no re-grouping is required, and a rejoin is needed if the grouping columns appearing only in the grouping list of the query are columns of common tables and any of them and their equivalent columns are not in a SELECT list of the query.

5. The method of claim 1, wherein the matching step further comprises:
if there are one or more extra columns in both a view definition for the materialized view and the query, then there is a matching requirement that grouping columns appearing in grouping lists of both the query and the view definition and the grouping columns appearing only in the grouping list of the view definition functionally determine the grouping columns appearing only in the grouping list of the query, re-grouping is required if the grouping columns appearing in the grouping lists of both the query and the view definition and the grouping columns appearing only in the grouping list of the query do not functionally determine the grouping columns appearing only in the grouping list of the view definition, and rejoin is needed if the grouping columns appearing only in the grouping list of the query are columns of common tables and any of them and their equivalent columns are not in a SELECT list of the query.

6. The method of claim 1, wherein, when no re-grouping is required, if a residual table exists in a FROM list of the query, then determining whether the residual table's join columns to the materialized view are all columns of a unique index key, and, if not, performing a re-grouping.

7. The method of claim 1, wherein the matching step further comprises:
if there is an exact match between grouping columns without considering columns from residual tables, then there is no further matching requirement, re-grouping is required if the grouping columns appearing in grouping lists of both the query and a view definition for the materialized view do not functionally determine the grouping columns from the residual tables appearing in the grouping list of the query, and no rejoin is needed.

8. The method of claim 1, wherein the matching step further comprises:
if there are one or more extra columns in a view definition for the materialized view only without considering columns from residual tables, then there is no further matching requirement, re-grouping is required if grouping columns appearing in grouping lists of both the query and the view definition and the grouping columns from the residual tables appearing in the grouping list of the query do not functionally determine the grouping columns appearing only in the grouping list of the view definition and the grouping columns appearing in the grouping lists of both the query and the view definition and the grouping columns appearing only in the grouping list of the view definition do not functionally determine the grouping columns from the residual tables appearing in the grouping list of the query, and no rejoin is needed.

9. The method of claim 1, wherein the matching step further comprises:
if there are one or more extra columns in the query only without considering columns from residual tables, then there is a matching requirement that grouping columns appearing in grouping lists of both the query and a view definition for the materialized view functionally determine the grouping columns appearing only in the grouping list of the query, re-grouping is required if the grouping columns appearing in the grouping lists of both the query and the view definition do not functionally determine the grouping columns from the residual tables appearing in the grouping list of the query, and a rejoin is needed if the grouping columns appearing only in the grouping list for the query are columns of common tables and any of them and their equivalent columns are not in a SELECT list of the query.

10. The method of claim 1, wherein the matching step further comprises:
if there are one or more extra columns in both a view definition for the materialized view and the query without considering columns from residual tables, then there is a matching requirement that grouping columns appearing in grouping lists of both the query and the view definition and the grouping columns appearing only in the grouping list of the view definition functionally determine the grouping columns appearing only in the grouping list of the query, re-grouping is required if the grouping columns appearing in the grouping lists of both the query and the view definition and the grouping columns appearing only in the grouping list of the query and the grouping columns for the residual tables appearing in the grouping list for the query do not functionally determine the grouping columns appearing only in the grouping list of the view definition and the grouping columns appearing in the grouping lists of both the query and the view definition and the grouping columns appearing only in the grouping list for the view definition do not functionally determine the grouping columns for the residual tables appearing in the grouping list of the query, and rejoin is needed if the grouping columns appearing only in the grouping list for the query are columns of common tables and any of them and their equivalent columns are not in a SELECT list of the query.

11. The method of claim 1, wherein the functional dependency comprises:
if a set of columns contains a primary key of a table, then the set of columns functionally determines any remaining columns of the table.

12. The method of claim 1, wherein the functional dependency comprises:
if a set of columns contains index key columns of a NOT NULL unique index of a table, then the set of columns functionally determines any and all remaining columns of the table.

13. The method of claim 1, further comprising recursively determining whether the functional dependency holds.

14. The method of claim 1, further comprising deriving one or more aggregate functions requested by the query from the materialized view and any remaining tables in the query based on the matched groupings.

15. The method of claim 14, further comprising deriving the aggregate functions requested by the query from the materialized view and the remaining tables in the query when the matched groupings indicate that re-aggregation needs to be performed.

16. The method of claim 14, further comprising deriving the aggregate functions requested by the query from the materialized view and the remaining tables in the query based on an argument of the aggregate functions.

17. The method of claim 14, further comprising deriving the aggregate functions with re-grouping.

18. The method of claim 17, further comprising deriving the aggregate functions with re-grouping involving columns of common tables.

19. The method of claim 17, further comprising deriving the aggregate functions with re-grouping involving columns of residual tables.

20. The method of claim 14, further comprising deriving the aggregate functions without re-grouping.

21. The method of claim 20, further comprising deriving the aggregate functions without re-grouping involving columns of common tables.

22. The method of claim 20, further comprising deriving the aggregate functions without re-grouping involving columns of residual tables.

23. A computer-implemented apparatus for optimizing a query, comprising:
(a) a computer system;
(b) logic, performed by the computer system, for
(1) identifying a materialized view candidate;
(2) matching a grouping of the materialized view with a grouping of the query using column equivalence and functional dependency, in order to determine whether re-aggregation is necessary, and
(3) rewriting the query based on the matched groupings.

24. An article of manufacture embodying logic for performing a method for optimizing a query, the query being performed by a computer system to retrieve data from a database stored in a data storage device coupled to the computer system, the method comprising:
(a) identifying a materialized view candidate;
(b) matching a grouping of the materialized view with a grouping of the query using column equivalence and functional dependency, in order to determine whether re-aggregation is necessary; and
(c) rewriting the query based on the matched groupings.

25. The article of manufacture of claim 24, wherein the matching step further comprises:
if there is an exact match between grouping columns, then there is no further matching requirement, no re-grouping and no rejoin are necessary.

26. The article of manufacture of claim 24, wherein the matching step further comprises:
if there are one or more extra columns in a view definition for the materialized view only, then there is no other matching requirement, re-grouping is required if grouping columns appearing in grouping lists of both the query and the view definition do not functionally determine the grouping columns appearing only in the grouping list of the view definition, and no rejoin is needed.

27. The article of manufacture of claim 24, wherein the matching step further comprises:
if there are one or more extra columns in the query only, then there is a matching requirement that grouping columns appearing in grouping lists of both the query and a view definition for the materialized view functionally determine the grouping columns appearing only in the grouping list of the query, no re-grouping is required, and a rejoin is needed if the grouping columns appearing only in the grouping list of the query are columns of common tables and any of them and their equivalent columns are not in a SELECT list of the query.

28. The article of manufacture of claim 24, wherein the matching step further comprises:
if there are one or more extra columns in both a view definition for the materialized view and the query, then there is a matching requirement that grouping columns appearing in grouping lists of both the query and the view definition and the grouping columns appearing only in the grouping list of the view definition functionally determine the grouping columns appearing only in the grouping list of the query, re-grouping is required if the grouping columns appearing in the grouping lists of both the query and the view definition and the grouping columns appearing only in the grouping list of the query do not functionally determine the grouping columns appearing only in the grouping list of the view definition, and rejoin is needed if the grouping columns appearing only in the grouping list of the query are columns of common tables and any of them and their equivalent columns are not in a SELECT list of the query.

29. The article of manufacture of claim 24, wherein, when no re-grouping is required, if a residual table exists in a FROM list of the query, then determining whether the residual table's join columns to the materialized view are all columns of a unique index key, and, if not, performing a re-grouping.

30. The article of manufacture of claim 24, wherein the matching step further comprises:
if there is an exact match between grouping columns without considering columns from residual tables, then there is no further matching requirement, re-grouping is required if the grouping columns appearing in grouping lists of both the query and a view definition for the materialized view do not functionally determine the grouping columns from the residual tables appearing in the grouping list of the query, and no rejoin is needed.

31. The article of manufacture of claim 24, wherein the matching step further comprises:
if there are one or more extra columns in a view definition for the materialized view only without considering columns from residual tables, then there is no further matching requirement, re-grouping is required if grouping columns appearing in grouping lists of both the query and the view definition and the grouping columns from the residual tables appearing in the grouping list of the query do not functionally determine the grouping columns appearing only in the grouping list of the view definition and the grouping columns appearing in the grouping lists of both the query and the view definition and the grouping columns appearing only in the grouping list of the view definition do not functionally determine the grouping columns from the residual tables appearing in the grouping list of the query, and no rejoin is needed.

32. The article of manufacture of claim 24, wherein the matching step further comprises:
if there are one or more extra columns in the query only without considering columns from residual tables, then there is a matching requirement that grouping columns appearing in grouping lists of both the query and a view definition for the materialized view functionally determine the grouping columns appearing only in the grouping list of the query, re-grouping is required if the grouping columns appearing in the grouping lists of both the query and the view definition do not functionally determine the grouping columns from the residual tables appearing in the grouping list of the query, and a rejoin is needed if the grouping columns appearing only in the grouping list for the query are columns of common tables and any of them and their equivalent columns are not in a SELECT list of the query.

33. The article of manufacture of claim 24, wherein the matching step further comprises:
if there are one or more extra columns in both a view definition for the materialized view and the query without considering columns from residual tables, then there is a matching requirement that grouping columns appearing in grouping lists of both the query and the view definition and the grouping columns appearing only in the grouping list of the view definition functionally determine the grouping columns appearing only in the grouping list of the query, re-grouping is required if the grouping columns appearing in the grouping lists of both the query and the view definition and the grouping columns appearing only in the grouping list of the query and the grouping columns for the residual tables appearing in the grouping list for the query do not functionally determine the grouping columns appearing only in the grouping list of the view definition and the grouping columns appearing in the grouping lists of both the query and the view definition and the grouping columns appearing only in the grouping list for the view definition do not functionally determine the grouping columns for the residual tables appearing in the grouping list of the query, and rejoin is needed if the grouping columns appearing only in the grouping list for the query are columns of common tables and any of them and their equivalent columns are not in a SELECT list of the query.

34. The article of manufacture of claim 24, wherein the functional dependency comprises:
if a set of columns contains a primary key of a table, then the set of columns functionally determines any remaining columns of the table.

35. The article of manufacture of claim 24, wherein the functional dependency comprises:
if a set of columns contains index key columns of a NOT NULL unique index of a table, then the set of columns functionally determines any and all remaining columns of the table.

36. The article of manufacture of claim 24, further comprising recursively determining whether the functional dependency holds.

37. The article of manufacture of claim 24, further comprising deriving one or more aggregate functions requested by the query from the materialized view and any remaining tables in the query based on the matched groupings.

38. The article of manufacture of claim 37, further comprising deriving the aggregate functions requested by the query from the materialized view and the remaining tables in the query when the matched groupings indicate that re-aggregation needs to be performed.

39. The article of manufacture of claim 37, further comprising deriving the aggregate functions requested by the query from the materialized view and the remaining tables in the query based on an argument of the aggregate functions.

40. The article of manufacture of claim 37, further comprising deriving the aggregate functions with re-grouping.

41. The article of manufacture of claim 40, further comprising deriving the aggregate functions with re-grouping involving columns of common tables.

42. The article of manufacture of claim 40, further comprising deriving the aggregate functions with re-grouping involving columns of residual tables.

43. The article of manufacture of claim 37, further comprising deriving the aggregate functions without re-grouping.

44. The article of manufacture of claim 43, further comprising deriving the aggregate functions without re-grouping involving columns of common tables.

45. The article of manufacture of claim 43, further comprising deriving the aggregate functions without re-grouping involving columns of residual tables.
